(19) United States
(12) Patent Application Publication
(10) Pub. No.: US 2016/0165235 A1
(43) Pub. Date: Jun. 9, 2016

(54) METHOD OF ENCODING IMAGE DATA, ENCODER USING THE METHOD, AND APPLICATION PROCESSOR INCLUDING THE ENCODER

(71) Applicant: SAMSUNG ELECTRONICS CO., LTD., Gyeonggi-do (KR)

(72) Inventor: Byeong Du LA, Gyeonggi-do (KR)

(73) Assignee: SAMSUNG ELECTRONICS CO., LTD.

(21) Appl. No.: 14/959,550

(22) Filed: Dec. 4, 2015

(30) Foreign Application Priority Data
Dec. 4, 2014 (KR) 10-2014-0173140

(51) Int. Cl. H04N 19/14; H04N 19/176; H04N 19/513

(52) U.S. Cl. CPC H04N 19/14; H04N 19/513; H04N 19/176

(57) ABSTRACT

A method of encoding image data, an encoder, and an application processor including the encoder are provided. The encoder includes a correlation measure block configured to compare macroblocks of a first frame with macroblocks of a second frame and to generate block correlation information for the macroblocks; and an encoding module configured to determine whether to perform inter prediction on an input macroblock of the second frame, based on a reference frame obtained by encoding and decoding the first frame and the second frame according to the block correlation information.

### PRIORITY

This application claims priority under 35 U.S.C. §119(a) to Korean Patent Application Serial No. 10-2014-0173140, which was filed in the Korean Intellectual Property Office on Dec. 4, 2014, the entire disclosure of which is incorporated herein by reference.

### BACKGROUND

1. Field of the Disclosure

The present disclosure relates generally to a method of encoding image data, an encoder using the method, and an application processor including the encoder, and more particularly, to an image data encoding method, which may be used by the encoder or the application processor including the decoder, for decreasing power consumption and an amount of computation.

2. Description of the Related Art

International standardization of video coding has been led by a Moving Picture Experts Group (MPEG) under International Organization for Standardization/International Electro-technical Commission (ISO/IEC) and a Video Coding Experts Group (VCEG) under International Telecommunications Union Telecommunication Standardization sector (ITU-T). MPEG and VCEG organized a Joint Video Team (JVT) and completed the international video coding standard, i.e., H.264/Advanced Video Coding (AVC). Unlike existing video codecs such as MPEG-2, MPEG-4, H.261, and H.263, H.264/ACV has introduced variable block size motion estimation, 1/4-pixel motion vector resolution, multiple reference picture motion estimation, etc., thereby improving compression capability as compared to existing codecs.

For example, an H.264/ACV codec performs motion estimation on a 4×4 block, so that motion estimation can be performed on up to sixteen 4×4 blocks in a 16×16 macro block. As a result, the H.264/ACV codec increases motion vector resolution to quarter-pixel precision, thereby performing more precise motion estimation than existing codecs.

However, the H.264/ACV codec calculates a residual signal between frames using multiple reference frames, thereby increasing the complexity of motion estimation compared to existing codec. The increase of motion vector resolution also increases motion estimation complexity. The complexity of H.264/ACV makes it difficult to apply H.264/ACV to an application such as a real-time video encoder. Therefore, technology for efficiently reducing the complexity but still maintaining high compression capability is desired.

The above-described problems are not restricted to H.264/ACV but will be applied to compression techniques which will be adopted as standards.

### SUMMARY

In accordance with an embodiment of the present disclosure, an encoder is provided, which includes a correlation measure block configured to compare macroblocks of a first frame with macroblocks of a second frame and to generate block correlation information for the macroblocks; and an encoding module configured to determine whether to perform inter prediction on an input macroblock of the second frame, based on a reference frame obtained by encoding and decoding the first frame and the second frame according to the block correlation information.

In accordance with another embodiment of the present disclosure, an application processor is provided, which includes a memory device configured to store image data including a plurality of frames; and an encoder configured to encode the image data. The encoder includes a correlation measure block configured to compare macroblocks of a first frame with macroblocks of a second frame and to generate block correlation information for the macroblocks, the first frame and the second frame being included in the image data; and an encoding module configured to determine whether to perform inter prediction on an input macroblock of the second frame, based on a reference frame obtained by encoding and decoding the first frame and the second frame according to the block correlation information.

In accordance with another embodiment of the present disclosure, a method is provided for encoding image data. The method includes comparing macroblocks of a first frame of image data with macroblocks of a second frame of image data; generating block correlation information for the macroblocks, based on the comparison; determining a reference frame by encoding and decoding the first frame and the second frame according to the block correlation information; and determining whether to perform inter prediction on an input macroblock of the second frame, based on the reference frame.

In accordance with another embodiment of the present disclosure, a system on chip (SoC) is provided, which includes a memory device configured to store image data including a plurality of frames; and an encoder configured to encode the image data. The encoder includes a correlation measure block configured to compare macroblocks of a first frame with macroblocks of a second frame and to generate block correlation information for the macroblocks, the first frame and the second frame being included in the image data; and an encoding module configured to determine whether to perform inter prediction on an input macroblock of the second frame, based on a reference frame obtained by encoding and decoding the first frame and the second frame according to the block correlation information.

### BRIEF DESCRIPTION OF THE DRAWINGS

The above and other aspects, features, and advantages of certain embodiments of the present disclosure will become more apparent from the following detailed description taken in conjunction with the accompanying drawings, in which:

FIG. 1 illustrates a data processing system according to an embodiment of the present disclosure;

FIG. 2 illustrates an encoder according to an embodiment of the present disclosure;

FIG. 3 illustrates an encoding module according to an embodiment of the present disclosure;

FIG. 4 illustrates image data input to into an encoder according to an embodiment of the present disclosure;

FIGS. 5 to 7 illustrate examples of an encoder processing image data according to an embodiment of the present disclosure; and

FIG. 8 is a flowchart of an encoding method performed by an encoder according to an embodiment of the present disclosure.

### DETAILED DESCRIPTION OF EMBODIMENTS OF THE DISCLOSURE

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

In the drawings, the size and relative sizes of layers and regions may be exaggerated for clarity. Like numbers refer to like elements throughout.

Herein, when an element is referred to as being “connected to” or “coupled to” another element, the element can be directly connected or coupled to the other element or intervening elements may be present therebetween. However, when an element is referred to as being “directly connected to” or “directly coupled to” another element, there are no intervening elements present.

As used herein, the phrase “and/or” includes any and all combinations of one or more of the associated listed items and may be abbreviated as “/”.

Herein, although the terms first, second, etc., may be used to describe various elements, these elements should not be limited by these terms. These terms are only used to distinguish one element from another. For example, a first signal may be referred to as a second signal, and similarly, a second signal may be referred to as a first signal without departing from the teachings of the present disclosure.

As used herein, the singular forms “a”, “an” and “the” are intended to include the plural forms as well, unless the context clearly indicates otherwise. The terms “comprises”, “comprising”, “includes”, and “including”, when used in this disclosure, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meanings as commonly understood by one of ordinary skill in the art to which this invention belongs. It will be further understood that terms, such as those defined in commonly used dictionaries, should be interpreted as having meanings that are consistent with their dictionary definitions in the context of the relevant art and/or the present disclosure, and will not be interpreted in idealized or overly formal senses, unless expressly so defined herein.

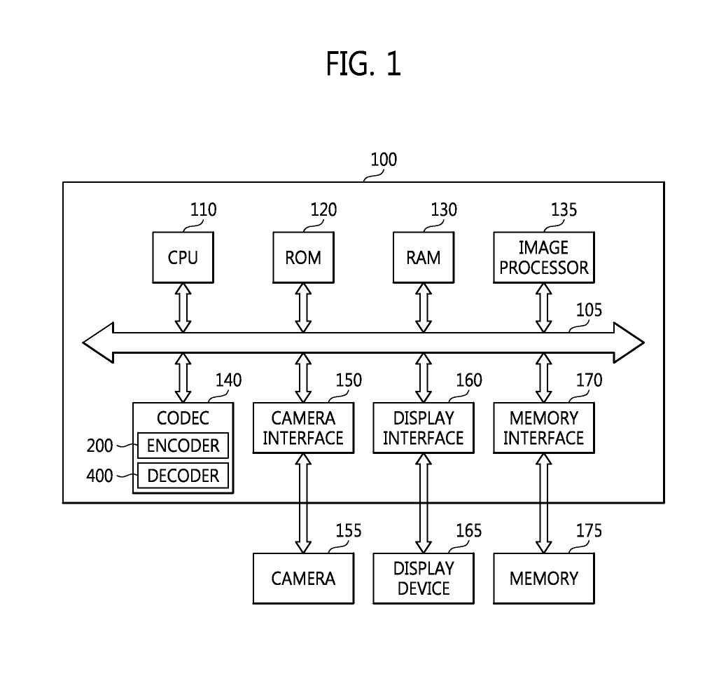

FIG. 1 illustrates a data processing system according to an embodiment of the present disclosure.

For example, the data processing system illustrated in FIG. 1 may be implemented as a mobile terminal such as a smart phone, a tablet personal computer (PC), a personal digital assistant (PDA), an enterprise digital assistant (EDA), a mobile internet device (MID), a video camcorder, or an e-book.

Referring to FIG. 1, the data processing system includes an application processor 100, a camera 155, a display device 165, and a memory 175.

The application processor 100 includes a central processing unit (CPU) 110, a read-only memory (ROM) 120, a random access memory (RAM) 130, an image processor 135, a codec 140, a camera interface 150, a display interface 160, and a memory interface 170, which communicate data with one another through a bus 105. The application processor 100 may be implemented as a system on chip (SoC).

The CPU 110 may control the overall operation of the application processor 100. For example, the CPU 110 may process or execute programs and/or data stored in the ROM 120 and/or the RAM 130. The CPU 110 may be a single computing component with two or more independent actual processors (or cores), i.e., a multi-core processor.

The ROM 120 stores permanent programs and/or data. The ROM 120 may also be implemented as erasable programmable ROM (EPROM) or electrically erasable programmable ROM (EEPROM).

The RAM 130 temporarily stores programs, data, and/or instructions. The RAM 130 may be implemented as dynamic RAM (DRAM) or static RAM (SRAM). The RAM 130 may temporarily store data input/output through the interfaces 150, 160, and 170 or data generated by the codec 140 or the CPU 110.

The image processor 135 performs image processing on data received, e.g., from the RAM 130, the camera interface 150, or the memory interface 170, and outputs the processed data to the RAM 130, the display interface 160, or the memory interface 170.

The codec 140 encodes or decodes data stored in the memory 120 or 130, data received from the camera 155, or data output to the display device 165. The codec 140 includes an encoder 200 and a decoder 400.

Although the codec 140 is formed outside the CPU 110, the camera interface 150, and the display interface 160 in the embodiment illustrated in FIG. 1, alternatively, the codec 140 may be included in the CPU 110, the camera interface 150, and/or the display interface 160. Basically, the scope of the disclosure is not limited by the disposition of the codec 140.

The codec 140 may be formed in software, hardware, or a combination thereof.

The camera interface 150 interfaces data (e.g., image data) input from the camera 155 in the outside of the application processor 100.

The camera 155 may generate data corresponding to an image picked up using a plurality of photosensitive elements.

The display interface 160 interfaces data (e.g., image data) output to the display device 165 in the outside of the application processor 100. For example, the display device 165 outputs image or video data using a liquid crystal display (LCD) or an active matrix organic light emitting diode (AMOLED) display.

The memory interface 170 interfaces data received from the memory 175 in the outside of the application processor 100 or data output to the memory 175. The memory 175 may be formed of non-volatile memory such as flash memory or resistive memory.

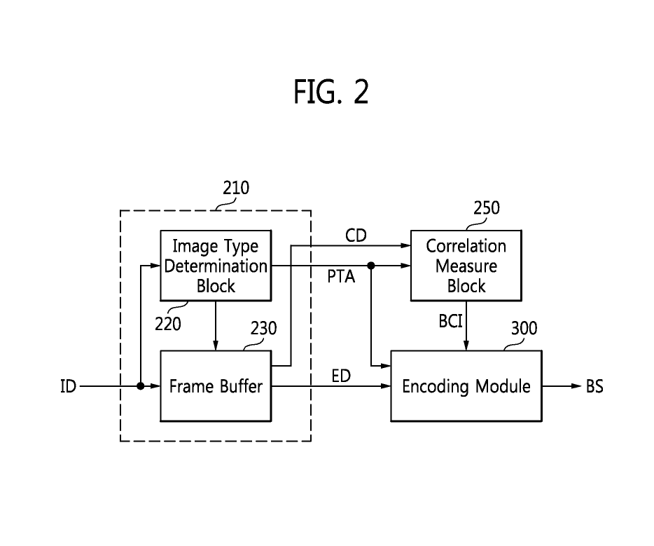

FIG. 2 illustrates an encoder according to an embodiment of the present disclosure. For example, the encoder illustrated in FIG. 2, may be used as the encoder 200 illustrated in FIG. 1.

Referring to FIG. 2, the encoder includes a pre-processing unit 210, a correlation measure block 250, and an encoding module 300.

The pre-processing unit 210 temporarily stores image data ID and generates signals for controlling the correlation measure block 250 and the encoding module 300 based on the image data ID. For example, the image data ID may be a continuous image of frames.

The pre-processing unit 210 includes an image type determination block 220 and a frame buffer 230.

The image type determination block 220 receives the image data ID and determines an image type of each of the frames in the image data ID. The image type is a kind of image according to which each frame is differently encoded by the encoding module 300. For example, a frame may be classified as an intra (I) frame, a predicted (P) frame, or a bidirectional (B) frame according to the image type.

An I-frame is a type referring to coding being performed using only intra prediction within a current frame, without involving any other frame.

A P-frame is a type referring to coding being performed using both inter prediction referring to a preceding frame and intra prediction.

A B-frame is a type referring to coding being performed using inter prediction referring to a preceding frame and a next future frame and intra prediction.

The image type determination block 220 assigns the image data ID to a particular image group in order to determine the image type of each frame. The size of the image group is determined by the assignment of an I-frame and the structure of the image group is determined by the arrangement of a P-frame and/or a B-frame. That is, the number of bits in the coded data can be reduced by the arrangement of a P-frame and a B-frame, and the size of the image group is restricted by intermittently assigning an I-frame, so that error propagation is prevented.

For example, the structure of the image group may be divided into an IPPP structure and an IBBBP structure. In the IPPP structure, the types of the frames therein are determined in order of I-frame, P-frame, P-frame, and P-frame. In the IBBBP mode, the types of the frames therein are determined in order of I-frame, B-frame, B-frame, B-frame, and P-frame.

The image type determination block 220 controls a frame output from the current frame buffer 230. More specifically, the order of frames in the image data ID may be different from the order in which the frames are coded according to the structure of the image group.

For example, when the image type determination block 220 assigns frames to the image group in the IBBBP structure, the order of frames is determined as IBBBP in the image data ID, but the encoding module 300 receives the frames in the image data ID in the order of IPBBB. Therefore, the image type determination block 220 may control the frame buffer 230 to output encoding data (ED) in the order of IPBBB from the image data ID stored therein in the order of IBBBP.

The image type determination block 220 may generate an image type assignment signal (PTA) indicating a type of each frame in the ED and may transmit the PTA to the correlation measure block 250 and the encoding module 300.

The frame buffer 230 temporarily stores the image data ID and outputs the ED in an encoding order determined according to the control of the image type determination block 220. The size of the frame buffer 230 may be determined according to the structure of the image group used by the image type determination block 220. For example, when the IBBBP structure is used, the frame buffer 230 may have a size allowing five frames to be stored.

Alternatively, the frame buffer 230 may be formed outside the encoder, for example, as a part of the RAM 130 illustrated in FIG. 1.

The correlation measure block 250 compares a first frame with a second frame according to the image type assignment signal (PTA) and generates block correlation information (BCI). The correlation measure block 250 may also compare the second frame with a third frame and generate the BCI.

The BCI is generated for each macroblock according to whether macroblocks at the same position in respective frames compared with each other are identical to each other. The second frame may be a current frame in the ED input to the encoding module 300, i.e., a current frame that is being encoded by the encoding module 300. The first frame may be determined by a type of the second frame which is determined by the PTA.

For example, when the PTA indicates that the second frame is an I-frame, the correlation measure block 250 generates the BCI regarding the first and second frames, but the encoding module 300 only performs intra prediction, without using the BCI.

When the PTA indicates that the second frame is a P-frame, the correlation measure block 250 generates the BCI including a first bit indicating whether the first frame is identical to the second frame. For example, the identicalness between the first and second frames may be determined according to a result of comparing each of pixels in the first frame with a pixel at a corresponding position in the second frame.

The correlation measure block 250 may determine that the first and second frames are identical to each other, when every pixel in a macroblock of the first frame is the same as a corresponding pixel in a corresponding macroblock of the second frame. The first frame may be a frame coming right before the second frame in light of the order of frames in the image data ID. The first bit of the BCI may be “0”, when corresponding macroblocks between the first and second frames are not identical to each other, and may be “1”, when corresponding macroblocks between the first and second frames are identical to each other.

When the PTA indicates that the second frame is a B-frame, the correlation measure block 250 generates the BCI including a first bit indicating whether the first frame is identical to the second frame and a second bit indicating whether the second frame is identical to the third frame. Here, the third frame is a P-frame belonging to the same image group as the second frame and the first frame is an I-frame belonging to the same image group as the second frame. The first bit of the BCI may be “0”, when corresponding macroblocks between the first and second frames are not identical to each other, and may be “1”, when the corresponding macroblocks between the first and second frames are identical to each other. Similarly, the second bit of the BCI may be “0”, when corresponding macroblocks between the second and third frames are not identical to each other, and may be “1”, when the corresponding macroblocks between the second and third frames are identical to each other.

The correlation measure block 250 may generate the BCI for each macroblock. A macroblock includes M pixels and N pixels in a matrix form, where M and N are integers of at least 1 and is an encoding unit of the encoding module 300. For example, the macroblock may have a size of 16×16 pixels. When the second frame includes 100 macroblocks, the BCI corresponding to the second frame may include 100 bits.

The correlation measure block 250 may determine frames for generating the BCI according to the PTA and may load comparison data (CD) corresponding to the determined frames from the frame buffer 230. That is, the correlation measure block 250 compares original frames included in the CD to generate the BCI, so that the BCI may accurately reflect the identicalness between frames in units of macroblocks.

The encoding module 300 may perform intra prediction and/or inter prediction according to the image type of the ED, based on the PTA, thereby generating an encoded bitstream (BS). Whether to perform inter prediction may be determined according to the BCI.

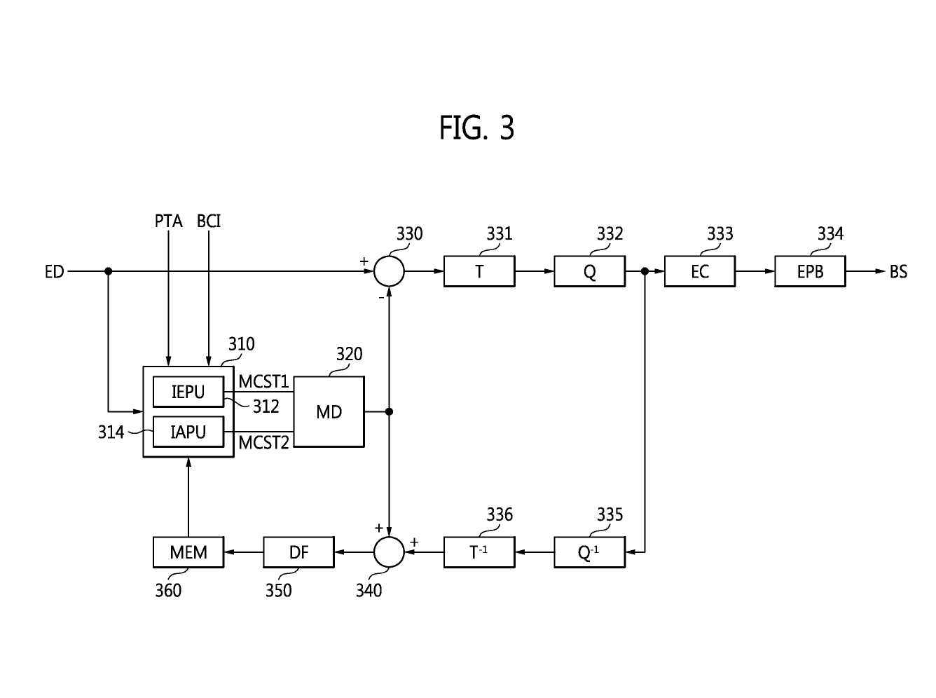

FIG. 3 illustrates an encoding module according to an embodiment of the present disclosure. For example, the encoding module illustrated in FIG. 3, may be used as the encoding module 300 illustrated in FIG. 2.

Referring to FIG. 3, the encoding module receives ED in units of macroblocks. The encoding module performs intra prediction and inter prediction, decides an encoding mode for each of macroblocks of the ED, and encodes each macroblock according to the encoding mode. The encoding module includes a prediction block 310, a mode decision block (MD) 320, a subtractor 330, a transform block (T) 331, a quantization block (Q) 332, an entropy coder (EC) 333, an encoded picture buffer (EPB) 334, an inverse quantization block (Q⁻¹) 335, an inverse transform block (T⁻¹) 336, an adder 340, a deblocking filter (DF) 350, and a reference frame memory (MEM) 360.

The prediction block 310 includes an inter prediction unit (IEPU) 312 that performs inter prediction on the ED received in units of macroblocks and an intra prediction unit (IAPU) 314 that performs intra prediction on the ED. Hereinafter, it is assumed that a currently encoded frame is the second frame.

The prediction block 310 performs intra prediction and/or inter prediction according to a frame type, such as I-frame, P-frame, or B-frame, as defined by the PTA. Herein, it is assumed that the BCI indicates that the second frame is not identical to the first frame and/or the third frame.

When the PTA indicates that the second frame is a P-frame and the BCI is at a low level, the inter prediction unit 312 performs inter prediction using a reference frame, i.e., a preceding frame (i.e., an I-frame or a P-frame belonging to the same image group as the current frame) that has been encoded and decoded immediately before the current frame, and the intra prediction unit 314 performs intra prediction based on the second frame.

When the PTA indicates that the second frame is a B-frame and at least one bit in the BCI is at a low level, the inter prediction unit 312 performs inter prediction using a reference frame, i.e., a previous frame (i.e., an I-frame or a P-frame belonging to the same image group as the current frame) that has been encoded and decoded, and the intra prediction unit 314 performs intra prediction based on the reference frame.

According to the H.264 standard, available coding modes for a macroblock are an inter mode and an intra mode. The inter mode includes five motion compensation modes, i.e., skip mode, 16*16 mode, 8*16 mode, 16*8 mode, and 8*8 mode. The 8*8 motion compensation mode includes three sub-modes, i.e., 8*4 mode, 4*8 mode, and 4*4 mode for an 8*8 sub-block. The intra mode includes four 16*16 intra prediction modes and nine 4*4 intra prediction modes.

In order to encode a macroblock in one of the available coding modes, the prediction block 310 may perform a rate-distortion optimization.

More specifically, the intra prediction unit 314 obtains, among the above-described intra modes, an intra mode giving a minimum intra rate-distortion cost (Jmd), which may be defined as shown in Equation (1).

Jmd=DISTmd+Kmd*Rmd (1)

In Equation (1), Kmd is a Lagrangian coefficient for mode decision, Rmd is the number of bits required to perform encoding in a candidate intra mode, and DISTmd is distortion of the difference between a pixel in a reconstructed macroblock provided from the reference frame memory 360 and a pixel in an input macroblock of the second frame. A sum of absolute differences (SAD), a sum of absolute transformed differences (SATD), or a sum of squared differences (SSD) may be used as a distortion function.

As described above, the intra prediction unit 314 calculates intra rate-distortion costs Jmd in respective intra modes and determines, as a minimum intra rate-distortion cost MCST2, information about an intra rate-distortion cost Jmd, which is minimum among the intra rate-distortion costs Jmd, and a macroblock corresponding to the intra rate-distortion costs Jmd, which is minimum.

The inter prediction unit 312 obtains an optimal motion vector for each inter mode, except for the skip mode. The optimal motion vector is a motion vector allowing an inter rate-distortion cost Jmt, which may be defined as shown in Equation (2), among candidate motion vectors to be minimum.

Jmt=DISTmt+Kmt*Rmt (2)

In Equation (2), Kmt is a Lagrangian coefficient for motion estimation; Rmt is the number of bits required to encode data using a candidate mode, a candidate reference frame, and a candidate motion vector; and DISTmt is distortion of the difference between a pixel in a motion-compensated macroblock generated using the candidate motion vector and a pixel in an input macroblock. Again, SAD, SATD, or SSD may be used as a distortion function.

A type of a candidate motion vector is usually determined depending on the size of a search window. When the encoding module 300 uses a plurality of reference frames, the operation for the optimal motion estimation is repeated with respect to each of the reference frames.

As described above, the inter prediction unit 312 calculates inter rate-distortion costs Jmt with respect to respective reference frames, respective candidate motion vectors, and respective inter modes; and determines, as a minimum inter rate-distortion cost MCST1, information about an inter rate-distortion cost Jmt, which is minimum among the inter rate-distortion costs Jmt, and a macroblock corresponding to the inter rate-distortion cost Jmt, which is minimum.

In the skip mode, the inter prediction unit 312 does not obtain an optimal motion vector but determines, as the minimum inter rate-distortion cost MCST1, information about an inter rate-distortion cost Jmt of a macroblock at the same position as the input macroblock in a reference frame and about the macroblock in the reference frame.

When the PTA indicates that the second frame is a P-frame and the BCI indicates that a macroblock to be encoded in the second frame is identical to a macroblock at the same position as the macroblock to be encoded in the first frame (that is, the first bit is at a high level), the inter prediction unit 312 determines the minimum inter rate-distortion cost MCST1 in the skip mode, without performing inter prediction (or motion estimation), and the intra prediction unit 314 performs intra prediction based on a reference frame provided from the reference frame memory 360. At this time, the mode decision block 320 may send a reference block corresponding to the minimum inter rate-distortion cost MCST1 to the subtractor 330 and the adder 340.

When the PTA indicates that the second frame is a B-frame and the BCI indicates that a macroblock to be encoded in the second frame is identical to both a macroblock at the same position as the macroblock to be encoded in the first frame and a macroblock at the same position in the third frame (that is, both the first and second bits are at a high level), the inter prediction unit 312 determines the minimum inter rate-distortion cost MCST1 in the skip mode, without performing inter prediction (or motion estimation), and the intra prediction unit 314 performs intra prediction based on reference frames provided from the reference frame memory 360. At this time, because there are two reference frames, information about an inter rate-distortion cost Jmt of a macroblock in the reference frame corresponding to the first or third frame that is identical to the second frame and about the macroblock in the reference frame is determined as the minimum inter rate-distortion cost MCST1.

The mode decision block 320 compares the minimum intra rate-distortion cost MCST2 with the minimum inter rate-distortion cost MCST1 and determines an encoding mode corresponding to the smaller of the costs MCST2 and MCST1.

When the inter prediction mode is the skip mode according to the BCI, the mode decision block 320 may obtain the inter rate-distortion cost Jmt of the macroblock in the reference frame and determine whether to reflect the inter rate-distortion cost Jmt to the minimum intra rate-distortion cost MCST2 to control the inter prediction unit 312.

The mode decision block 320 may provide information, such as a reference block and a motion vector, which correspond to the encoding mode, for the subtractor 330 and the adder 340. The reference block refers to information about a macroblock corresponding to the smaller of the costs MCST2 and MCST1.

The subtractor 330 subtracts the reference block received from the mode decision block 320 from the input macroblock, thereby generating a residual block.

The transform block 331 performs spatial transform on the residual block generated by the subtractor 330. For example, the spatial transform may be discrete cosine transform (DCT) or wavelet transform. A transform coefficient is obtained as a result of the spatial transform. When DCT is used as the spatial transform, a DCT coefficient is obtained. When wavelet transform is used as the spatial transform, a wavelet coefficient is obtained.

The quantization block 332 quantizes the transform coefficient obtained by the transform block 331. Quantization is an operation of classifying the transform coefficient expressed as a random value into a certain range and expressing the transform coefficient as a discrete value. Quantization may include scalar quantization and vector quantization. Simple scalar quantization divides the transform coefficient by a corresponding value in a quantization table and rounds a division result to the nearest integer value.

The entropy coder 333 performs lossless encoding on the quantized data output from the quantization block 332 and information such as intra prediction mode, reference frame number, and motion vector, thereby generating the BS. For example, the lossless encoding may be arithmetic coding like context-adaptive binary arithmetic coding (CABAC) or variable length coding like context-adaptive variable-length coding (CAVLC).

The BS may be buffered by the EPB 334 and then output.

The inverse quantization block 335, the inverse transform block 336, and the adder 340 decode the lossless-encoded data in reverse way and a decoding result thereof is used to generate a reconstructed picture.

More specifically, the inverse quantization block 335 inverse-quantizes the quantized data from received from the quantization block 332. The inverse quantization is a procedure reverse to the quantization.

The inverse transform block 336 performs inverse spatial transform on the inverse-quantization result and sends the result of the inverse spatial transform to the adder 340.

The adder 340 adds a signal from the inverse transform block 336 and the reference block from the mode decision block 320 to restore the input macroblock. The macroblock restored by the adder 340 is provided for the DF 350 and an image of an adjacent block in the reconstructed picture is provided for the intra prediction unit 314.

The DF 350 performs deblock filtering with respect to a border of each macroblock. The deblock-filtered data is stored in the reference frame memory 360 and is used as a reference frame.

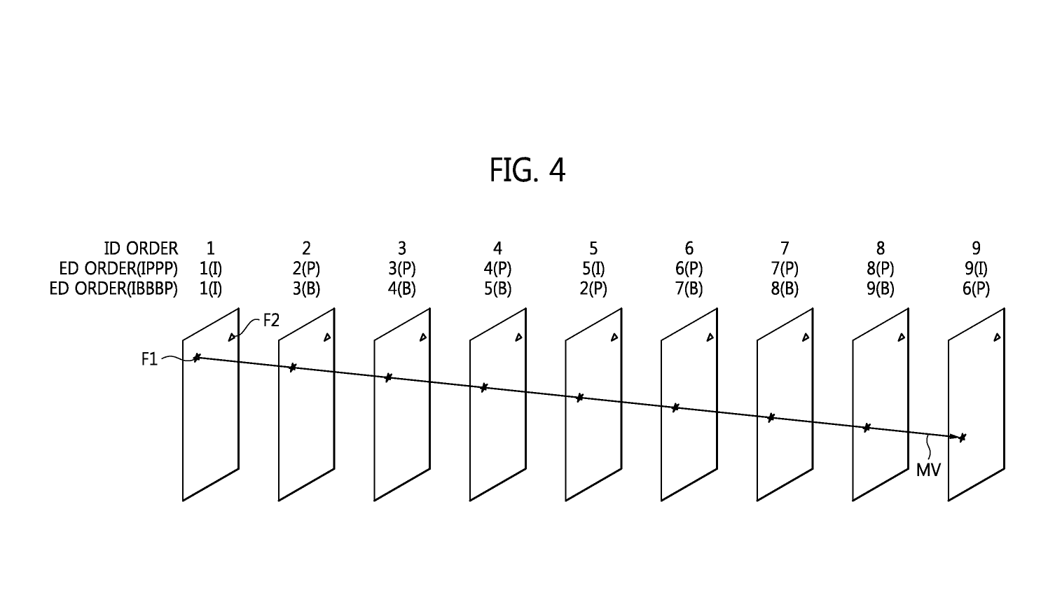

FIG. 4 illustrates image data input to into an encoder according to an embodiment of the present disclosure.

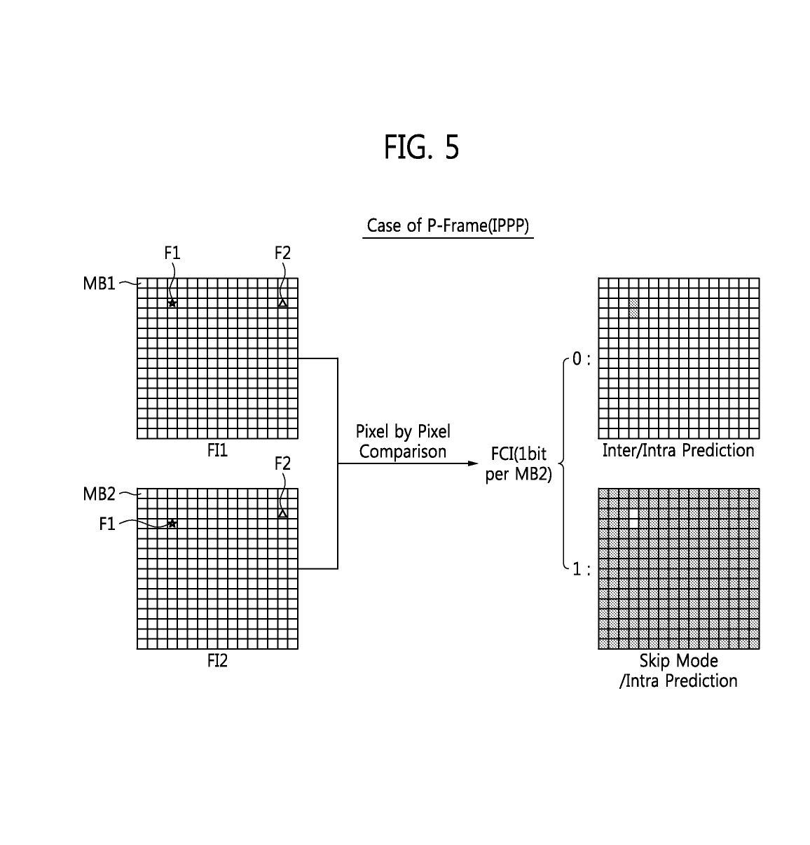

FIGS. 5 to 7 illustrate examples of an encoder processing image data according to an embodiment of the present disclosure.

Referring to FIG. 4, nine consecutive frames of the image data ID are arranged in frame order, i.e., an ID order. Each frame includes a first figure F1 and a second figure F2. It is assumed that the first figure F1 moves vertically along a predetermined motion vector (MV) as it moves frame to frame, but the second frame F2 remains in one place.

When the IPPP structure is used, an encoding order, i.e., ED order of IPPP for the ED is the same as the frame order, i.e., the ID order.

When the IBBBP structure is used, the encoding order, i.e., ED order of IBBBP for the ED is different from the frame order, i.e., the ID order, because when the IBBBP structure is used, the fifth frame in the frame order, i.e., the ID order of the first image group, should be encoded as a P-frame after the first frame in the frame order, i.e., the ID order is encoded as an I-frame. Thereafter, the second through fourth frames in the frame order, i.e., the ID order, are sequentially encoded as B-frames. Thereafter, the ninth frame in the frame order is encoded as a P-frame and then the sixth through eighth frames in the frame order are sequentially encoded as B-frames.

An operation of an encoder that encodes a second frame FI2 according to an image type of the second frame FI2 will be described below with reference to FIGS. 5 to 7. Herein, it is assumed that a first frame FI1 includes 16*16 macroblocks MB1, the second frame FI2 includes 16*16 macroblocks MB2, and a third frame FI3 include 16*16 macroblocks MB3, and that each of the macroblocks MB1, MB2, and MB3 includes 16*16 pixels. However, the inventive concept is not restricted to these examples.

The second frame FI2 is second in the frame order, i.e., the ID order, in the IPPP structure in the embodiment illustrated in FIG. 5. Accordingly, the first frame FI1 is first in the frame order.

Although FIG. 5 is described with reference to a scenario in which the second frame FI2 is second in the frame order, i.e., the ID order, an encoder may operate in the same manner as that described below when the second frame FI2 is in another position within the frame order.

Referring to FIG. 5, a correlation measure block, e.g., the correlation measure block 250 as illustrated in FIG. 2, compares macroblocks MB1 and MB2 placed at the same positions between the first and second frames FI1 and FI2, pixel by pixel, and generates BCI of one bit for the macroblock MB2 (since the second frame FI2 is a P-frame). Accordingly, the BCI corresponding to a macroblock MB2 positioned at the third row and the fourth column of the second frame FI2 and to a macroblock MB2 positioned at the fourth row and the fourth column of the second frame FI2 has a value of “0”.

When an encoding module 300, e.g., the encoding module 300 as illustrated in FIG. 2, encodes the macroblock MB2 positioned at the third row and the fourth column of the second frame FI2 and the macroblock MB2 positioned at the fourth row and the fourth column of the second frame FI2, both inter prediction and intra prediction may be performed.

However, the BCI corresponding to the macroblocks MB2 excluding the macroblocks MB2 positioned at the third row and the fourth column of the second frame FI2 and the macroblock MB2 positioned at the fourth row and the fourth column of the second frame FI2 has a value of “1”.

When the encoding module encodes the macroblocks MB2 excluding the macroblock MB2 positioned at the third row and the fourth column of the second frame FI2 and the macroblock MB2 positioned at the fourth row and the fourth column of the second frame FI2, an inter prediction unit, e.g., the inter prediction unit 312 as illustrated in FIG. 3, does not perform inter prediction in the skip mode and determines the minimum inter rate-distortion cost MCST1 using a reference frame corresponding to the first frame FI1, and the intra prediction unit performs intra prediction, according to the BCI of “1”, because determining the identicalness between macroblocks using the BCI corresponding to a result of comparing original frames, i.e., the first frame FI1 and the second frame FI2, with each other provides a more accurate matching result than comparing an input macroblock with a reference frame obtained by encoding and decoding the original frame, i.e., the first frame FI1.

In addition, although inter prediction is ideally supposed to be performed on every input macroblock, inter prediction consuming a lot of power may be selectively performed using only information about the original frames, i.e., the first and second frames FI1 and FI2, so that power consumption is remarkably reduced.

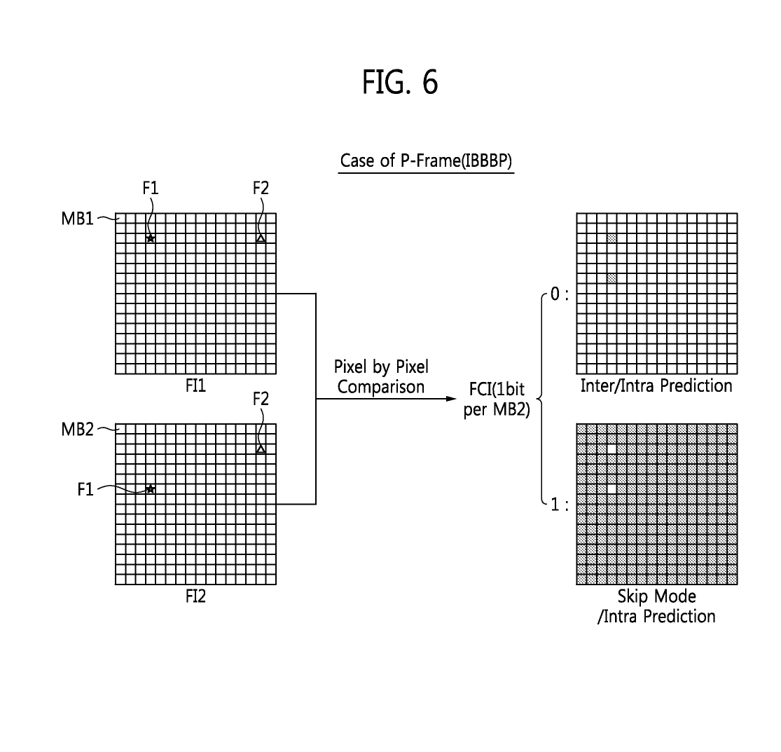

Referring to FIG. 6, the second frame FI2 is fifth in the frame order, i.e., the ID order, in the IBBBP structure. The first frame FI1 is first in the frame order. Although FIG. 6 is described with reference to a scenario in which the second frame FI2 is fifth in the frame order, an encoder according to an embodiment of the present disclosure may operate in the same manner as that described below, when the second frame FI2 is positioned in another place in the frame order.

Referring to FIG. 6, a correlation measure block, e.g., the correlation measure block 250 as illustrated in FIG. 2, compares macroblocks MB1 and MB2 placed at the same positions between the first and second frames FI1 and FI2, pixel by pixel, and generates the BCI of one bit for the macroblock MB2 (since the second frame FI2 is a P-frame). Accordingly, the BCI corresponding to the macroblock MB2 positioned at the third row and the fourth column of the second frame FI2 and to a macroblock MB2 positioned at the seventh row and the fourth column of the second frame FI2 has a value of “0”.

When an encoding module, e.g., the encoding module 300 as illustrated in FIG. 2, encodes the macroblock MB2 positioned at the third row and the fourth column of the second frame FI2 and the macroblock MB2 positioned at the seventh row and the fourth column of the second frame FI2, both inter prediction and intra prediction may be performed.

However, the BCI corresponding to the macroblocks MB2, excluding the macroblocks MB2 positioned at the third row and the fourth column of the second frame FI2 and the macroblock MB2 positioned at the seventh row and the fourth column of the second frame FI2, has a value of “1”.

When the encoding module encodes the macroblocks MB2, excluding the macroblock MB2 positioned at the third row and the fourth column of the second frame FI2 and the macroblock MB2 positioned at the seventh row and the fourth column of the second frame FI2, an inter prediction unit, e.g., the inter prediction unit 312 as illustrated in FIG. 3, does not perform inter prediction in the skip mode and determines the minimum inter rate-distortion cost MCST1 using a reference frame corresponding to the first frame FI1 and the intra prediction unit 314 performs intra prediction, according to the BCI of “1”.

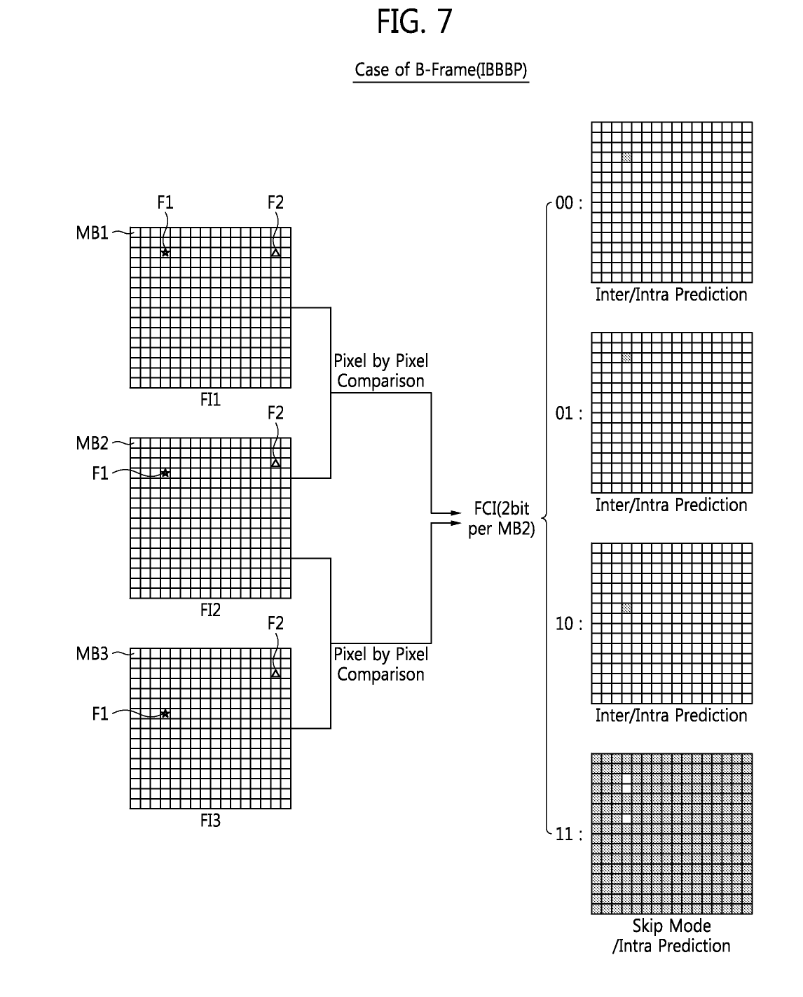

Referring to FIG. 7, the second frame FI2 is second in the frame order, i.e., the ID order, in the IBBBP structure. The first frame FI1 (i.e., an I-frame) is first and the third frame FI3 (i.e., a P-frame) is fifth in the frame order. Although FIG. 7 is described with reference to a scenario in which the second frame FI2 is second in the frame order, an encoder according to an embodiment of the present disclosure may operate in the same manner as that described below, when the second frame FI2 is positioned in another place in the frame order.

Referring to FIG. 7, a correlation measure block, e.g., the correlation measure block 250 as illustrated in FIG. 2, compares macroblocks MB1 and MB2 placed at the same positions between the first and second frames FI1 and FI2 and compares the macroblocks MB2 and MB3 placed at the same positions between the second and third frames FI2 and FI3, pixel by pixel, and generates BCI of two bits for the macroblock MB2 (since the second frame FI2 is a B-frame). Accordingly, the BCI corresponding to the macroblock MB2 positioned at the fourth row and the fourth column of the second frame FI2 has a value of “00”.

When an encoding module, e.g., the encoding module 300 as illustrated in FIG. 2, encodes the macroblock MB2 positioned at the fourth row and the fourth column of the second frame FI2, both inter prediction and intra prediction are performed.

The BCI corresponding to the macroblock MB2 positioned at the third row and the fourth column of the second frame FI2 has a value of “01”.

When the encoding module encodes the macroblock MB2 positioned at the third row and the fourth column of the second frame FI2, both inter prediction and intra prediction are performed.

The BCI corresponding to the macroblock MB2 positioned at the seventh row and the fourth column of the second frame FI2 has a value of “10”.

When the encoding module encodes the macroblock MB2 positioned at the seventh row and the fourth column of the second frame FI2, both inter prediction and intra prediction are performed.

The BCI corresponding to the macroblocks MB2 excluding the macroblocks MB2 positioned at the third row and the fourth column of the second frame FI2, the macroblock MB2 positioned at the fourth row and the fourth column of the second frame FI2, and the macroblock MB2 positioned at the seventh row and the fourth column of the second frame FI2 has a value of “11”.

When the encoding module encodes the macroblocks MB2 excluding the macroblock MB2 positioned at the third row and the fourth column of the second frame FI2, the macroblock MB2 positioned at the fourth row and the fourth column of the second frame FI2, and the macroblock MB2 positioned at the seventh row and the fourth column of the second frame FI2, an inter prediction unit, e.g., the inter prediction unit 312 as illustrated in FIG. 3, does not perform inter prediction in the skip mode and determines the minimum inter rate-distortion cost MCST1 using a reference frame corresponding to the first frame FI1 or the third frame FI3, and the intra prediction unit performs intra prediction according to the BCI of “11”.

Consequently, the encoder selectively performs inter prediction using a result of comparing the original frames FI1, FI2, and FI3, thereby reducing unnecessary operations and power consumption. In addition, the encoder decides an encoding mode using a result of comparing original frames FI1, FI2, and FI3, thereby providing a more accurate encoding result.

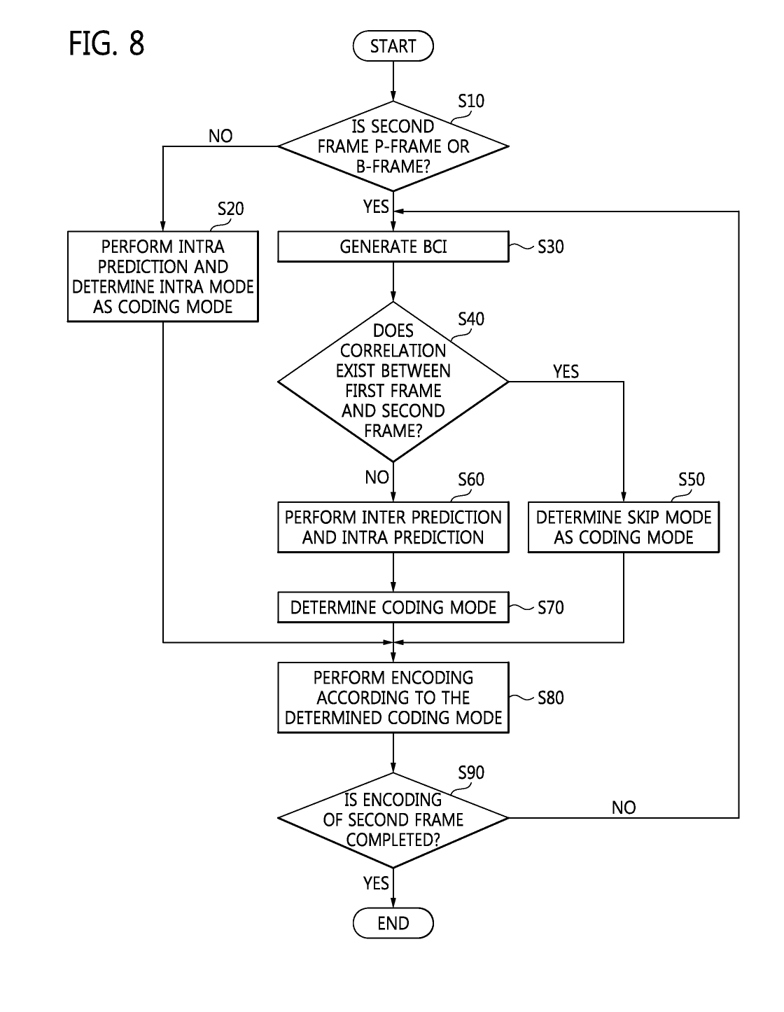

FIG. 8 is a flowchart illustrating an encoding method performed by an encoder according to an embodiment of the present disclosure. For example, FIG. 8 will be described below with reference to the encoder illustrated in FIG. 2 and the encoding module illustrated in FIG. 2.

Referring to FIG. 8, the correlation measure block 250 determines whether the second frame FI2 is a P-frame or a B-frame, based on the PTA in step S10.

When the second frame FI2 is neither a P-frame nor a B-frame, but is an I-frame in step S10, the encoding module 300 performs intra prediction according to the PTA, and the mode decision block 320 determines the intra mode as the coding mode in step S20.

However, when the second frame FI2 is either a P-frame or a B-frame in step S10, the correlation measure block 250 compares the second frame FI2 with the first frame FI1 and/or the third frame FI3 according to the PTA and generates the BCI in step S30. The correlation measure block 250 generates the BCI even when the second frame FI2 is an I-frame, but the encoding module 300 determines the encoding mode regardless of the BCI.

In step S40, it is determined whether the BCI indicates that a correlation exists between the second frame FI2 and either of the first and third frames FI1 and FI3. When it is determined that the BCI indicates that a correlation exists between the second frame FI2 and either of the first and third frames FI1 and FI3 in step S40, the inter prediction unit 312 does not perform inter prediction in the skip mode and the mode decision block 320 determines the skip mode as the coding mode in step S50.

However, when it is determined that the BCI indicates that a correlation does not exist between the second frame FI2 and either of the first and third frames FI1 and FI3 in step S40, the inter prediction unit 312 performs inter prediction and the intra prediction unit 314 performs intra prediction in step S60.

In step S70, the mode decision block 320 determines the coding mode according to the prediction result obtained in step S60.

In step S80, the encoding module 300 encodes an input macroblock of the second frame FI2 according to the determined coding mode.

Encoding is performed on each macroblock, and therefore, steps S30 through S90 are repeated all of the input macroblocks of the second frame FI2 are encoded.

As described above, according to an embodiments of the present disclosure, inter prediction is selectively performed based on a result of comparing original frames with each other in an encoder or an application processor including the encoder, thereby reducing unnecessary operations and power consumption.

In addition, a coding mode is determined based on the result of comparing the original frames, thereby increasing encoding accuracy.

While the present disclosure has been particularly shown and described with reference to certain embodiments thereof, it will be understood by those of ordinary skill in the art that various changes in forms and details may be made therein without departing from the spirit and scope of the present disclosure as defined by the following claims and any equivalents thereof.

1. An encoder comprising:
a correlation measure block configured to compare macroblocks of a first frame with macroblocks of a second frame and to generate block correlation information for the macroblocks; and
an encoding module configured to determine whether to perform inter prediction on an input macroblock of the second frame, based on a reference frame obtained by encoding and decoding the first frame and the second frame according to the block correlation information.

2. The encoder of claim 1, wherein the correlation measure block is configured to generate the block correlation information at a high level, when the first frame is identical to the second frame, based on the comparison, and to generate the block correlation information at a low level, when the first frame is not identical to the second frame, based on the comparison.

3. The encoder of claim 1, wherein when the block correlation information is at a high level, the encoding module is further configured to perform encoding by performing an operation on the input macroblock and a reference block corresponding to a skip mode, without performing the inter prediction.

4. The encoder of claim 1, wherein when the block correlation information is at a low level, the encoding module is further configured to perform the inter prediction and intra prediction, and to perform encoding by performing an operation on the input macroblock and a reference block corresponding to a mode determined by a result of the inter prediction and the intra prediction.

5. The encoder of claim 1, wherein the correlation measure block is further configured to determine a number of bits in the block correlation information based on an image type assignment signal indicating an image type of the second frame.

6. The encoder of claim 5, wherein the correlation measure block is further configured to generate the block correlation information comprising a first bit indicating whether the first frame and the second frame are identical to each other, when the image type assignment signal indicates that the second frame is a P-frame, and
wherein the encoding module is further configured to determine whether to perform the inter prediction based on the block correlation information.

7. The encoder of claim 5, wherein the correlation measure block is further configured to generate the block correlation information comprising a first bit indicating whether the first frame and the second frame are identical to each other and generate a second bit indicating whether the second frame and a third frame are identical to each other, when the image type assignment signal indicates that the second frame is a B-frame, and
wherein the encoding module is further configured to determine whether to perform the inter prediction based on the block correlation information.

8. An application processor comprising:
a memory device configured to store image data including a plurality of frames; and
an encoder configured to encode the image data,
wherein the encoder comprises:
a correlation measure block configured to compare macroblocks of a first frame with macroblocks of a second frame and to generate block correlation information for the macroblocks, the first frame and the second frame being included in the image data; and
an encoding module configured to determine whether to perform inter prediction on an input macroblock of the second frame, based on a reference frame obtained by encoding and decoding the first frame and the second frame according to the block correlation information.

9. The application processor of claim 8, wherein the correlation measure block is configured to generate the block correlation information at a high level, when the first frame is identical to the second frame, based on the comparison, and to generate the block correlation information at a low level, when the first frame is not identical to the second frame, based on the comparison.

10. The application processor of claim 8, wherein when the block correlation information is at a high level, the encoding module is further configured to perform encoding by performing an operation on the input macroblock and a reference block corresponding to a skip mode, without performing the inter prediction.

11. The application processor of claim 8, wherein when the block correlation information is at a low level, the encoding module is further configured to perform the inter prediction and intra prediction, and to perform encoding by performing an operation on the input macroblock and a reference block corresponding to a mode determined by a result of the inter prediction and the intra prediction.

12. The application processor of claim 8, wherein the correlation measure block is further configured to determine a number of bits in the block correlation information based on an image type assignment signal indicating an image type of the second frame.

13. The application processor of claim 12, wherein the correlation measure block is further configured to generate the block correlation information comprising a first bit indicating whether the first frame and the second frame are identical to each other, when the image type assignment signal indicates that the second frame is a P-frame, and
wherein the encoding module is further configured to determine whether to perform the inter prediction based on the block correlation information.

14. The application processor of claim 12, wherein the correlation measure block is further configured to generate the block correlation information comprising a first bit indicating whether the first frame and the second frame are identical to each other and generate a second bit indicating whether the second frame and a third frame are identical to each other, when the image type assignment signal indicates that the second frame is a B-frame, and
wherein the encoding module is further configured to determine whether to perform the inter prediction based on the block correlation information.

15-20. (canceled)

21. A system on chip (SoC) comprising:
a memory device configured to store image data including a plurality of frames; and
an encoder configured to encode the image data,
wherein the encoder comprises:
a correlation measure block configured to compare macroblocks of a first frame with macroblocks of a second frame and to generate block correlation information for the macroblocks, the first frame and the second frame being included in the image data; and
an encoding module configured to determine whether to perform inter prediction on an input macroblock of the second frame, based on a reference frame obtained by encoding and decoding the first frame and the second frame according to the block correlation information.

22. The SoC of claim 21, wherein the correlation measure block is configured to generate the block correlation information at a high level, when the first frame is identical to the second frame, based on the comparison, and to generate the block correlation information at a low level, when the first frame is not identical to the second frame, based on the comparison.

23. The SoC of claim 21, wherein when the block correlation information is at a high level, the encoding module is further configured to perform encoding by performing an operation on the input macroblock and a reference block corresponding to a skip mode, without performing the inter prediction.

24. The SoC of claim 21, wherein when the block correlation information is at a low level, the encoding module is further configured to perform the inter prediction and intra prediction, and to perform encoding by performing an operation on the input macroblock and a reference block corresponding to a mode determined by a result of the inter prediction and the intra prediction.

25. The SoC of claim 21, wherein the correlation measure block is further configured to determine a number of bits in the block correlation information based on an image type assignment signal indicating an image type of the second frame,
wherein the correlation measure block is further configured to generate the block correlation information comprising a first bit indicating whether the first frame and the second frame are identical to each other, when the image type assignment signal indicates that the second frame is a P-frame, and
wherein the encoding module is further configured to determine whether to perform the inter prediction based on the block correlation information.

26. The SoC of claim 21, wherein the correlation measure block is further configured to determine a number of bits in the block correlation information based on an image type assignment signal indicating an image type of the second frame,
wherein the correlation measure block is further configured to generate the block correlation information comprising a first bit indicating whether the first frame and the second frame are identical to each other and generate a second bit indicating whether the second frame and a third frame are identical to each other, when the image type assignment signal indicates that the second frame is a B-frame, and
wherein the encoding module is further configured to determine whether to perform the inter prediction based on the block correlation information.
